(19) United States
(12) Patent Application Publication
(10) Pub. No.: US 2023/0266134 A1
(43) Pub. Date: Aug. 24, 2023

(54) System and Method for Suggesting Most-Fuel Efficient Travel Route

(71) Applicant: James Chase, Camas, WA (US)

(72) Inventor: James Chase, Camas, WA (US)

(21) Appl. No.: 17/862,774

(22) Filed: Jul. 12, 2022

Related U.S. Application Data
(60) Provisional application No. 63/313,443, filed on Feb. 24, 2022.

(51) Int. Cl. G01C 21/34; G01C 21/36

(52) U.S. Cl. CPC G01C 21/3469; G01C 21/3423; G01C 21/3676; G01C 21/3697

(57) ABSTRACT

The present invention relates to a navigation system and a computer implemented method for suggesting a fuel-efficient route, an energy-efficient route, or other optimized travel parameter route from an origin location to a destination location. The system generates a map displaying a plurality of alternative routes to the destination location. Based on a plurality of route travel parameters, a route from the plurality of the routes, for example a route estimated to consume the least amount of energy, is suggested and highlighted. Depending on preference of a user, at least a distance between the origin and the destination, a travel time between the origin and the destination, and an elevation change along the alternative routes between the origin and the destination can be considered as the route travel parameters.

### CROSS-REFERENCE TO RELATED APPLICATION

The present application claims priority to, and the benefit of, U.S. Provisional Application No. 63/313,443, which was filed on Feb. 24, 2022 and is incorporated herein by reference in its entirety.

### FIELD OF THE INVENTION

The present invention relates generally to the field of navigation systems and route guiding. More specifically, the present invention relates to a novel navigation system that displays a plurality of routes from an origin location to a destination location while suggesting the most optimal fuel-efficient route for conserving fuel and energy. The navigation system enables users to avoid significant hills and other steep elevation changes that can produce significant CO2 and use several more gallons of fuel compared to other travel routes. Accordingly, the present disclosure makes specific reference thereto. Nonetheless, it is to be appreciated that aspects of the present invention are also equally applicable to other like applications, devices, and methods of manufacture.

### BACKGROUND

By way of background, a mapping and navigation system and application can present a map of a geographical location selected by a user. The system further presents driving directions that enable the user to drive from an origin location to a destination location. The driving directions may include a graphical component, for example, a graphical marking of the suggested driving route on a graphical map presented to the user. Additionally, or alternatively, the driving directions may include a textual component, for example, textual phrases instructing the user how to drive to reach the destination.

All the current map and navigation applications on the market are nearly identical in providing an end user with turn-by-turn navigation, alternate routes to mitigate traffic, road construction information, road closures providing detours, road hazards, duration of a trip, estimated time of arrival, gas station locations, advertisements, and other functions aiding a driver to make the best-informed decision on how, and which alternative route, to drive to reach the destination. Although, the heretofore known map systems and applications have different display formats and appearances, the purpose and information provided to the users is essentially the same.

Current map systems and applications do not offer a feature that provides any feedback on how the end user or driver can optimize their fuel consumption, or energy conservation in an electric vehicle based on geographic elevation differences and length of a route. In an attempt to reach a destination by travelling the least distance or in the least amount of time as offered by map systems, users can unwittingly ultimately spend more money on fuel, produce more CO2 by driving on steep elevation changes, and spend more money on maintaining their vehicle due to excessive use. People desire a map system that helps in lowering a car’s fuel consumption and CO2 emissions.

Therefore, there exists a long felt need in the art for a navigation system and method that offer directions to a destination based on the most optimal route for conserving fuel and energy. There is also a long felt need in the art for a navigation system and method that provides energy consumption based on elevation changes throughout the routes. Additionally, there is a long felt need in the art for a navigation system and application that enable users to avoid significant hills and other steep elevation changes in their route. Moreover, there is a long felt need in the art for a navigation system and application that helps in saving fuel, reduces emission of CO2, and maintains fuel efficiency. Further, there is a long felt need in the art for a navigation system and application that automatically suggest the most fuel-efficient and environment friendly path to a destination location. Finally, there is a long felt need in the art for a navigation system and application that offer a more economical and environmentally beneficial navigation application for traveling for users.

The subject matter disclosed and claimed herein, in one embodiment thereof, comprises a navigation system for suggesting the most optimal route between an origin and a destination for conserving fuel and energy. The system further comprising a non-transitory machine-readable medium having instructions stored thereon which when read and executed by at least one processor causes the at least one processor to perform operations comprising receiving a request for a plurality of routes for navigating from an origin location to a destination location; receiving a plurality of route parameters for suggesting the most optimal fuel efficient route from the origin location to the destination location; generating a map corresponding to a plurality of routes from the origin location to the destination location; generating a path or route table including the plurality of routes wherein distance, estimated time, and miles per gallon information for each path are included in the path or route table; suggesting the most optimal path from the plurality of paths wherein the most optimal path is selected based on route with calculated highest miles per gallon (mpg) and causing the generated map and the generated path or route table to be displayed within a user interface of a computing device of a user. The plurality of route parameters can comprise at least distance between origin and destination, travel time between the origin and destination, elevation changes along a route, and calculated mpg (i.e. fuel consumption) of each route.

In this manner, the navigation system and associated application of the present invention accomplishes all of the forgoing objectives and provide users with a modified navigation software application designed to offer directions to a specific location based on the most optimal route for conserving fuel and energy. The system enables users to input a destination and obtain several routes detailing energy consumption based on elevation changes throughout the trip. Users can select the most fuel-efficient path (i.e. least fuel consumed) and therefore reduces CO2 production and fuel.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a system for providing the most optimal route between an origin and a destination for conserving fuel and energy. The system further comprising a non-transitory machine-readable medium having instructions stored thereon which when read and executed by at least one processor cause the at least one processor to perform operations comprising receiving a request for a route for navigating from an origin location to a destination location; receiving a plurality of route parameters for suggesting the most optimal fuel efficient route from the origin location to the destination location; generating a map of a geographical area corresponding to a plurality of routes from the origin location to the destination location; generating a path or route table including the plurality of routes wherein distance, estimated time, and miles per gallon (mpg) information for each path are included in the path or route table; suggesting the most optimal path from the plurality of paths wherein the most optimal path is selected based on route with highest miles per gallon, or least fuel consumed (i.e. calculated total gallons of fuel consumed), and causing the generated map and the generated path or route table to be displayed within a user interface of a computing device of a user. The mpg information can be based on vehicle information entered into the system by the user including vehicle year, vehicle make, and vehicle model; or alternatively the mpg information can by interfaced and sourced from an electronic vehicle unit (ECU).

In yet another embodiment, a computer implemented method for suggesting the most optimal route to a destination location from an origin location for conserving fuel and energy is described. The method comprising receiving, by a computing device having a memory and at least one processor, a request for a map display for navigating from the origin location to the destination location; generating, by the computing device, a plurality of map routes based on the request, the map includes a geographical area corresponding to the plurality of routes from the origin location to the destination location; generating, by the computing device, a path or route table including the plurality of routes wherein distance, estimated time, miles per gallon, and fuel consumption information for each path are included in the path or route table; and suggesting the most optimal path from the plurality of paths wherein the most optimal path is selected based on the highest miles per gallon and/or least amount of fuel consumed.

In some embodiments, the method includes displaying an elevation variation along a route wherein the route is from the origin location to the destination location.

In yet another embodiment, the method further includes receiving selection of at least one route parameters used for suggesting the most optimal route by the system.

In some embodiments, the method includes receiving an origin location; a destination location; selection of a plurality of route parameters wherein the parameters at least include distance between the origin and destination, travel time between the origin and destination, and elevational changes (i.e. altimeter recordings) along routes from the origin and destination.

In some embodiments, the navigation system includes a map generator for generating and rendering a map; a route generator for generating routes from an origin location to a destination location; a navigation module for suggesting the most optimal path based on the miles per gallon and/or total fuel consumption calculation for each route generated by the route generator.

In some embodiments, the elevational changes along routes from the origin and destination is given more weightage than distance between the origin and destination, and/or travel time between the origin and destination.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a block diagram showing core software modules of the vehicle map and navigation system of the present invention in accordance with the disclosed architecture;

FIG. 2 illustrates a block diagram of an exemplary computing device used for accessing the vehicle map and navigation system of the present invention via a computer implemented application in accordance with the disclosed architecture;

FIG. 3 illustrates a flow diagram depicting a process of working of the navigation system via machine readable instructions in accordance with the disclosed architecture;

FIG. 4 illustrates schematic block diagram showing exemplary route parameters used by the navigation system of the present invention for selecting the most optimal route between an origin location and a destination location;

FIG. 5 illustrates an exemplary input table provided by the navigation system of the present invention for a user to input route parameters for suggesting the most optimal route in accordance with the disclosed architecture; and

FIG. 6 illustrates an exemplary user interface illustration which may be generated using an embodiment of the system of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, destination routes based on the most optimal route for conserving fuel and energy is desired. There is also a long felt need in the art for a navigation system and method that provides energy consumption based on distance and elevation changes throughout the routes. Additionally, there is a long felt need in the art for a navigation system and application that enable users to avoid significant hills and other steep elevation changes in their route. Moreover, there is a long felt need in the art for a navigation system and application that helps in saving fuel, reduces emission of CO2, and maintains fuel efficiency. Further, there is a long felt need in the art for a navigation system and application that automatically suggest the most fuel-efficient and environment friendly path or route to a destination location. Finally, there is a long felt need in the art for a navigation system and application that offer a more economical and environmentally beneficial navigation application for traveling for users.

The present invention, in one exemplary embodiment, is a computer implemented method for suggesting the most optimal route to a destination location from an origin location The method comprising receiving, by a computing device, a request for a map display for navigating from the origin location to the destination location; generating, by the computing device, a plurality of alternative routes on the map based on the request, the map includes a geographical area corresponding to the plurality of routes from the origin location to the destination location; generating, by the computing device, a path or route table including the plurality of routes wherein distance, estimated time, miles per gallon, and fuel consumption information for each path are included in the path or route table; and suggesting the most optimal path from the plurality of paths wherein the most optimal path is selected based on the highest miles per gallon and/or lowest fuel consumption. It is to be appreciated that fuel consumption or energy consumption can be calculated in calories burned (i.e. kilocalories) when the user is a hiker or bicyclist. A calorie is a measure of energy expenditure and stored energy. The calories referred to in diet (calories eaten) and exercise (calories burned) are kilocalories (kcal). One kilocalorie is equal to the amount of heat that will raise the temperature of one kilogram of water by one degree Celsius at sea level.

Embodiments of the present invention can be used in conjunction with various devices, for example, a personal computer (PC), a desktop computer, a laptop, a notebook computer, a tablet, a server computer, a handheld computer, any handheld electronic device, a personal digital assistant (PDA) device, a handheld PDA device, an on-board device, a vehicular device, a non-vehicular device, a mobile or portable device, a non-mobile or non-portable device, a display unit, a monitor, a projector device, a set-top box, a wireless communication device, and more.

Embodiments of the invention may be used in conjunction with one or more types of wireless communication signals and/or systems, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, discrete multi-tone (DMT), Bluetooth (®), global positioning system (GPS), Wi-Fi, ZigBee (™), global system for mobile communication (GSM), 2G, 2.5G, 3G, 3.5G, 4G, 5G, 6G or the like. Embodiments of the invention may be used in various other devices, systems and/or networks.

The term “map” as used herein may include, for example, a street-based map, a road-based map, a street map, a road map, a geographical map, a vector map, a raster map, a topographic map, a city map, a digital chart, a bird’s eye view map, a satellite map, a pictorial map, a 2D map, a 3D map, a traffic map, or the like.

Although embodiments of the invention are not limited in this regard, the term “user” as used herein may include, for example, an end user, an intermediary user, an operator, a consumer, a driver, a hiker, a traveler, a rider, a bicyclist, or the like.

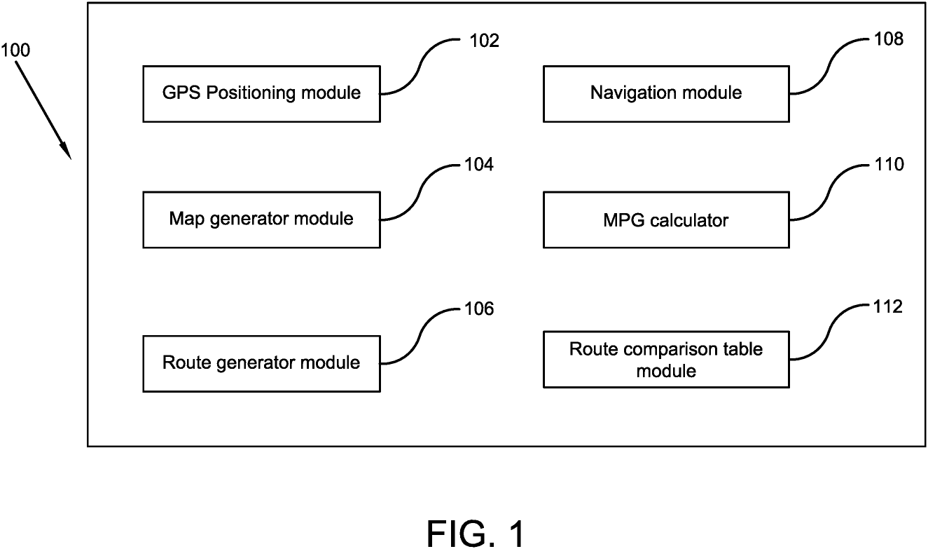

Referring initially to the drawings, FIG. 1 illustrates a block diagram showing core software modules of the vehicle map and navigation system of the present invention in accordance with the disclosed architecture. The vehicle map and navigation system 100 of the present invention is configured to provide users with the most informed decision to optimize their driving, hiking, biking, el. al. routes based on geographic elevation gains/losses and distance to conserve fuel and energy. The system 100 helps users in maximizing fuel efficiency and conserving fuel/energy while still quickly reaching their destination location. The system 100 of the present invention may be implemented, using a machine-readable medium or article which may store an instruction or a set of instructions that, are configured to be executed by a machine or device. The machine may include, for example, any suitable computing device, processing device, computing system, processing system, computer, processor, or the like, and may be implemented using any suitable combination of hardware and/or software.

The software modules of the system 100 may be written in a suitable computer programming language such as C, C++, Python or Java, however any other language is also suitable. All of the components may be conventional (or other than conventional) and the manufacture and use of these components are known to those of skill in the art.

The system 100 includes a GPS positioning module 102 which is configured to receive data concerning the GPS coordinates of the current location of a user/vehicle in which the system 100 and the associated computer implemented application is installed. Based on the signals from a constellation of satellites which form part of the GPS, the GPS positioning module 102 determines the GPS coordinates of the user/vehicle. A map generator module 104 is configured to generate and/or render a map or a portion thereof, for example, corresponding to geographical area or corresponding to a route between an origin location and a destination location. The map generator module 104 may be operable with one or more location databases stored in a central location such as a cloud server (not shown), for example for generating real time map.

A route generator module 106 is configured to take feeds from the GPS positioning module 102 for creating a plurality of routes corresponding to a route between an origin location and a destination location. The created routes are displayed on the map rendered by the map generator module 104. A navigation module 108 is configured to perform analysis of the created routes for determining at least distance, estimated travel time, and geographic elevation gain/loss for each route. The navigation module 108 takes feed from the location databases used by the system of the present invention.

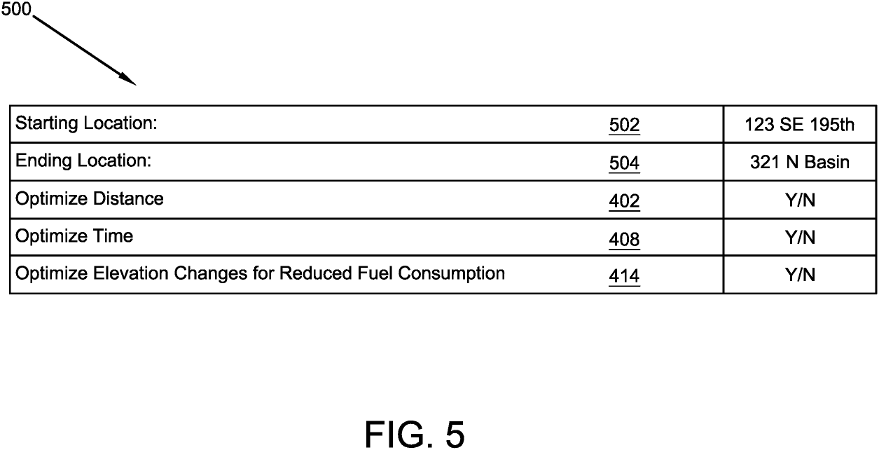

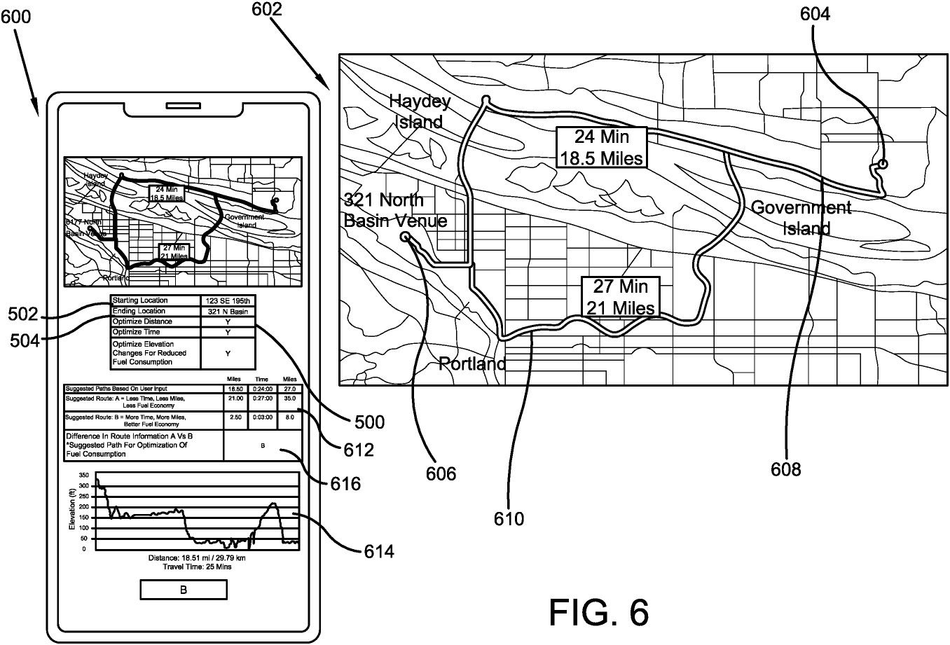

A miles per gallon (MPG) calculator module 110 is configured to take feed from the navigation module 108 and calculates MPG for each route by considering the geographical elevation or altitude gain/loss of planned routes, mileage of a vehicle configured in the system 100 by a user, and more. The mileage (i.e. calculated MPG) of the vehicle can be based on vehicle information entered into the system by the user including vehicle year, vehicle make, and vehicle model. Based on the calculated MPG and total miles traveled by the module 110 and parameters of the routes by the navigation module 108, a route comparison table module 112 generates a path or route table rendered below the map (as illustrated in FIGS. 5 and 6) and suggesting the most optimal route from the origin location to the destination location to conserve fuel and energy (i.e. gasoline, battery kilowatt-hours [kWh], kcals, et. al.).

(i.e. kcal). The suggested path may not be the shortest path or the path with the least time but can be the path conserving the most fuel and energy, thereby offering more economical and environmentally beneficial navigation for traveling for users.

It should be appreciated that the system 100 and the associated application generate a map that includes additional information like landmarks, Point-of-interest (POI), route information and more as available in conventional maps like Google maps, Apple maps and more. Further, the map is also configured to display direction information like “Turn right at Walmart”, and “Turn left at 24th street”. In some embodiments, the map may generate, provide and/or display information such as distance information, time information, or the like relative to one or more landmarks and to a destination. In some embodiments, additional information like estimated time of arrival (ETA) to destination, an improved understanding by the user of the area of his destination, or the like is also displayed on the map.

In some embodiments, the navigation system 100 and/or components thereof are multilingual. For example, system 100 may be able to receive input or data in one or more languages and may be able to generate and/or present output or data in one or more languages.

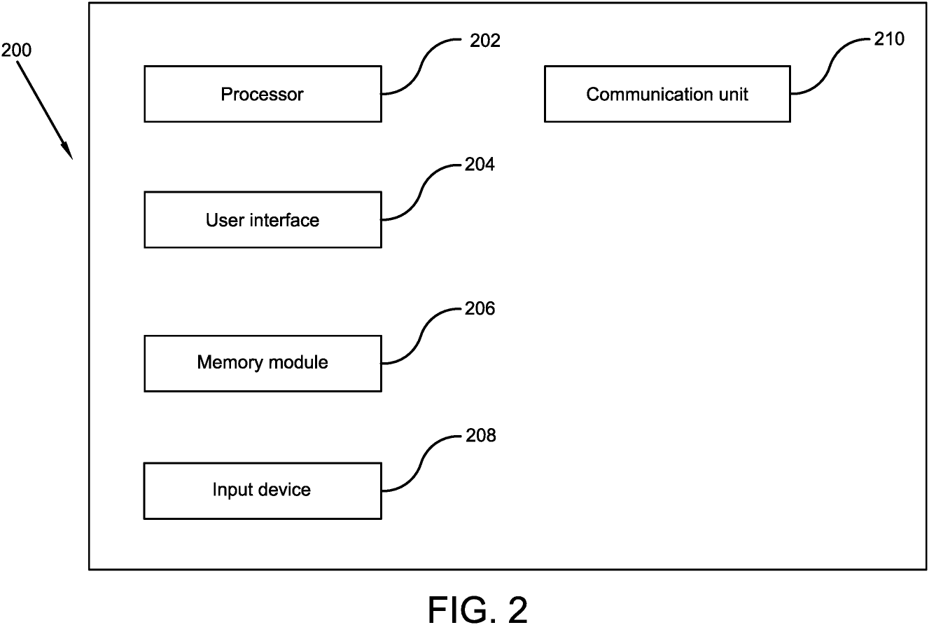

FIG. 2 illustrates a block diagram of an exemplary computing device used for accessing the vehicle map and navigation system of the present invention via a computer implemented application in accordance with the disclosed architecture. The software components of the navigation system 100 are associated with a computing device in the form of a computer implemented application containing instructions that are executed by a processor 202 of the computing device 200. The computing device 200 may include, for example, any suitable computing device, processing device, computing system, processing system, computer, processor, or the like, and may be implemented using any suitable combination of hardware and/or software.

The processor 202 is configured to receive input from user interface 204 wherein the user interface 204 enables a user to input information and obtain information from the navigation system 100 and/or the vehicle ECU. The input information may include a request for the most optimal route and other functions of the system 100. The maps, routes, and the path or route table provided by the system 100 are rendered on the user interface 204 of the device 200. The processor 202 may include, for example, an electronic control unit (ECU), a central processing unit (CPU), a digital signal processor (DSP), a microprocessor, a host processor, a controller, a plurality of processors or controllers, a chip, a microchip, one or more circuits, circuitry, a logic unit, an integrated circuit (IC), an application-specific IC (ASIC), or any other suitable multi-purpose or specific processor or controller.

A memory 206 is used for storing machine-readable medium or article and includes a RAM that is used for running the system 100 in the device 200. The memory 206 may include, for example, a random-access memory (RAM), a read only memory (ROM), a dynamic RAM (DRAM), a synchronous DRAM (SD-RAM), a flash memory, a volatile memory, a non-volatile memory, a cache memory, a buffer, a short-term memory unit, a long term memory unit, or other suitable memory units or storage units.

An input device 208 of the device 200 is configured to be used by a user for providing input to the system 100. The input device 208 can be a keyboard, a keypad, a mouse, a touch-pad, a stylus, a scanner, a microphone, or other suitable pointing device or input device. The touch-based user interface 204 can also function as the input device. The system 100 receives input including an input indicating a request to find a plurality of routes from an origin location to a destination location, an input indicating a request to find the most optimal route, an input indicating a request to set parameters for selecting the most optimal route and many more.

A communication unit 210 may include a wired or wireless receiver and/or transmitter, a wired or wireless transmitter-receiver and/or transceiver, a radio frequency (RF) communication unit or transceiver, a GPS unit, a GPS chip, a GPS receiver, a GPS transceiver, or other units able to transmit and/or receive signals, blocks, frames, transmission streams, packets, messages and/or data.

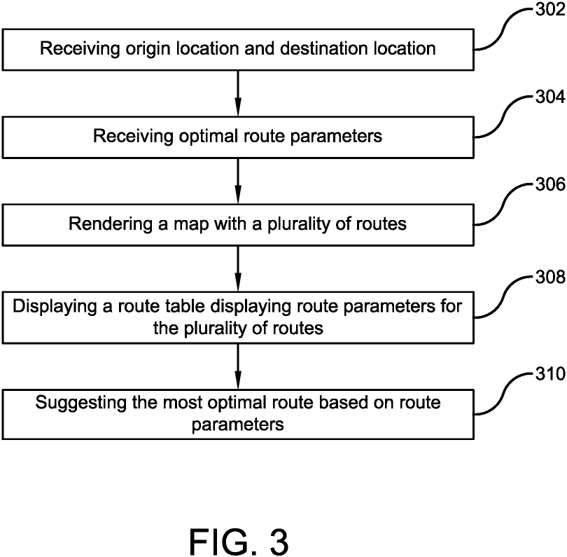

FIG. 3 illustrates a flow diagram depicting a process of working of the navigation system via machine readable instructions in accordance with the disclosed architecture. Initially, an origin location and a destination location are received from an input device of a device in which the system is being used by a user (Step 302). Then, selection of one or more route parameters used for suggesting the most optimal route between the origin location and the destination location are received (Step 304). Based on the input origin location and destination location, a map is generated and rendered by the map generator module (Step 306). The rendered map also displays a plurality of routes identified by the system between the origin location and destination location.

Thereafter, based on the identified routes and the received route parameters, a path or route table is generated and displayed including the route parameters for each route of the plurality of routes (Step 308). The route parameters may include, but not limited to, distance, travel time, energy consumption (i.e. gallons of gas, kcal, et. al.), elevational changes, and more. A route with the most optimized selected route parameters is suggested and displayed by the system enabling users to avoid significant hills and other steep elevation changes that can produce significant CO2 and use several more gallons of fuel or kcals compared to other travel routes (Step 310).

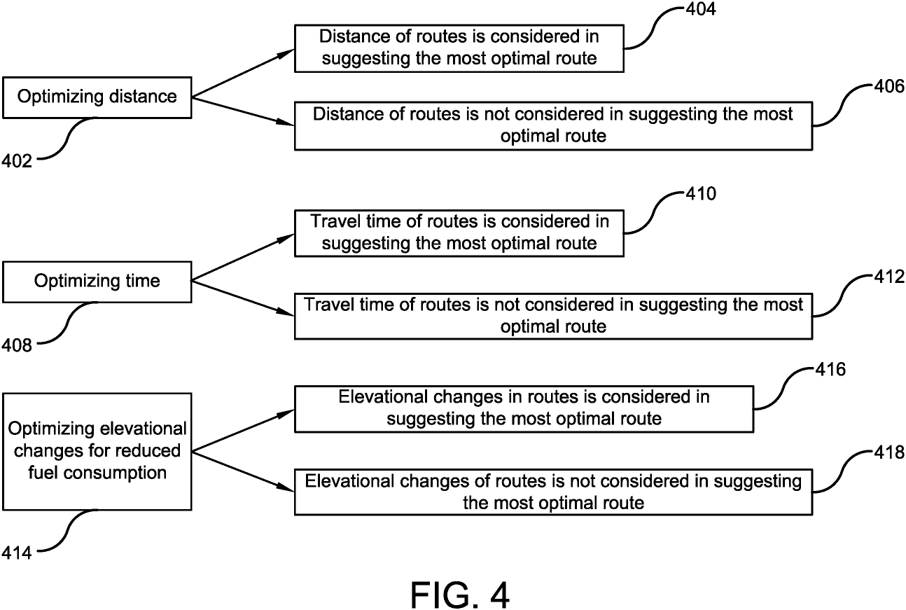

FIG. 4 illustrates schematic block diagram showing exemplary route parameters used by the navigation system of the present invention for selecting the most optimal route between an origin location and a destination location. It should be understood that the route parameters included in the present embodiment are exemplary and any number of additional parameters can be included for suggesting the most optimal route.

The first parameter 402 is distance between the origin location and the destination location. When the distance is selected as a route parameter, then, distance of each route is considered by the system in suggesting the most optimal route between the origin and the destination (404). When the distance is not selected, then, the distance is not considered for selecting the most optimal route (406).

The second parameter 408 is travel time between the origin location and the destination location. When the travel time is selected as a route parameter, then, travel time of each route is considered by the system in suggesting the most optimal route between the origin and the destination (410). When the travel time is not selected, then, the travel time is not considered for selecting the most optimal route (412).

The third parameter 414 is elevational changes in routes between the origin location and the destination location. When the parameter elevational changes are selected as a route parameter, then, documented elevational changes, and/or comparison of gains and losses of the vehicle altimeter recordings or altitude readings, of each route are considered by the system in suggesting the most optimal route between the origin and the destination (416). When the elevational changes are not selected, then, the elevational changes are not considered for selecting the most optimal route (418).

FIG. 5 illustrates an exemplary input table provided by the navigation system of the present invention for a user to input route parameters or variables for suggesting the most optimal route in accordance with the disclosed architecture. As illustrated, a starting (origin) location 502 is input by the user. The starting location can also be automatically detected by the positioning system and does not require a user to manually select the origin location. The ending (destination) location 504 is manually input by the user. In some embodiments, the destination can be searched using a landmark, address, GPS coordinates, or more by a user.

The table 500 provides a plurality of route parameters or variables including optimizing distance 402, optimizing travel time 408, and/or optimizing elevational changes for reduced fuel consumption or energy expenditure 414. Each parameter can be individually enabled or disabled as per preference of a user and accordingly, the system using the navigation module and the MPL calculator suggests the most optimal path to the user.

FIG. 6 illustrates an exemplary user interface illustration which may be generated using an embodiment of the system of the present invention in accordance with the disclosed architecture. As schematically illustrated in FIG. 6, a generated map 602 may include, for example, road-based indications as well as landmark-based indications. In some embodiments, optionally, a bubble, a balloon, a pushpin, or other identifier may be presented in proximity to the landmark, for example, to provide a textual description or name or logo or other details about the landmark.

The map 602 also displays the origin location 604 and the destination location 606 along with a plurality of routes 608, 610 from the origin 604 to the destination 606. Below the map, the table 500 is displayed illustrating the textual origin location 502 and destination location 504. Based on the selected routing parameters, a route table 612 is displayed. The route table 612 displays the routes 608, 610 in individual rows with the corresponding values of the routing parameters 402, 408, 414. Based on the selected parameters or variables discussed supra, the optimized route 616 from the origin to the destination is displayed to indicate to a user about the most fuel-efficient (i.e. least energy consumed) route.

It should be noted that when the fuel efficiency (elevational changes) is considered as a parameter, the system gives more weightage for the elevation gains and losses (i.e. gains and losses of altimeter recordings) to the routing parameter 414 enabling the system to suggest the most fuel-efficient route even when it has a longer travel duration and/or a longer travel distance.

The interface 600 also displays a graphical representation 614 illustrating the elevational changes, or altimeter recordings, during a route from the origin to the destination enabling users to check the elevational changes in the route. The steepness of terrain, hills, and more are displayed in the graphical representation 614.

The system also considers the additional factors such as average fuel consumption for vehicles along the routes, steepness, types of roads and more to calculate fuel efficiency of routes and helps in suggesting the most optimal route for conserving fuel and energy (i.e. gasoline, battery kilowatt-hours [kWh], kcals, et. al.).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “navigation system”, “vehicle map and navigation system”, “map system”, and “system” are interchangeable and refer to the vehicle map and navigation system 100 of the present invention for sunglasses.

Notwithstanding the forgoing, the vehicle map and navigation system 100 of the present invention can be of any suitable size and configuration as is known in the art without affecting the overall concept of the invention, provided that it accomplishes the above stated objectives. One of ordinary skill in the art will appreciate that the vehicle map and navigation system 100 as shown in the FIGS. are for illustrative purposes only, and that many other configurations of the vehicle map and navigation system 100 are well within the scope of the present disclosure.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

Some embodiments may include devices and/or systems using one or more suitable Operating Systems, for example, Microsoft Windows, Microsoft Windows CE, Microsoft Windows Embedded, Microsoft Windows Mobile, Unix, iOS, Linux, Sun Solaris, Palm OS, J2ME, BREW, an OS used by BlackBerry device(s), or other suitable Operating Systems.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for optimizing a travel parameter, the system comprising:
a GPS positioning module configured to receive data concerning GPS coordinates of an origin location and a destination location;
a map generator module configured to generate a map corresponding to a geographical area between said origin location and said destination location;
a route generator module configured to take feeds from said GPS positioning module for creating a plurality of alternative routes corresponding between said origin location and said destination location;
wherein said plurality of alternative routes displayed on said map;
a navigation module configured to perform analysis of said plurality of alternative routes for determining travel parameters comprising at least a distance, an estimated travel time, and geographic elevation gains and losses for each of said plurality of alternative routes; and
further wherein said navigation module configured to perform further analysis of energy consumption for each of said plurality of alternative routes.

2. The system for optimizing a travel parameter of claim 1, wherein said energy consumption is gallons of gasoline.

3. The system for optimizing a travel parameter of claim 1, wherein said energy consumption is kilocalories.

4. The system for optimizing a travel parameter of claim 1, wherein said energy consumption is battery kilowatt-hours [kWh].

5. The system for optimizing a travel parameter of claim 2, wherein said plurality of alternative routes are driving routes.

6. The system for optimizing a travel parameter of claim 3, wherein said plurality of alternative routes are hiking routes.

7. The system for optimizing a travel parameter of claim 3, wherein said plurality of alternative routes are bicycling routes.

8. The system for optimizing a travel parameter of claim 4, wherein said plurality of alternative routes are driving routes.

9. A system for optimizing energy consumption, the system comprising:
a GPS positioning module configured to receive data concerning GPS coordinates of an origin location and a destination location;
a map generator module configured to generate a map corresponding to a geographical area between said origin location and said destination location;
a route generator module configured to take feeds from said GPS positioning module for creating a plurality of alternative routes corresponding between said origin location and said destination location;
wherein said plurality of alternative routes displayed on said map;
a navigation module configured to perform analysis of said plurality of alternative routes for determining a group of travel parameters selected from a group consisting of a distance, a travel time, a geographic elevation gain and loss, and an energy consumption for each of said plurality of alternative routes; and
further wherein determining said energy consumption is selected from a group consisting of a quantity of gasoline, a battery kilowatt-hour [kWh], and a kilocalorie.

10. The system for optimizing energy consumption of claim 9, wherein said navigation module further determines a travel parameter comprising MPG of a vehicle for each of said plurality of alternative routes.

11. The system for optimizing energy consumption of claim 10, wherein said navigation module interfaced with a vehicle electronic control unit for determining said MPG of the vehicle.

12. The system for optimizing energy consumption of claim 11, wherein said plurality of alternative routes further comprise an estimated time of arrival (ETA) to said destination location.

13. The system for optimizing energy consumption of claim 9, wherein said plurality of alternative routes are driving routes.

14. The system for optimizing energy consumption of claim 9, wherein said plurality of alternative routes are hiking routes.

15. The system for optimizing energy consumption of claim 9, wherein said plurality of alternative routes are bicycling routes.

16. A system for optimizing travel parameters, the system comprising:
a GPS positioning module configured to receive data concerning GPS coordinates of an origin location and a destination location;
a map generator module configured to generate a map corresponding to a geographical area between said origin location and said destination location;
a route generator module configured to take feeds from said GPS positioning module for creating a plurality of alternative routes corresponding between said origin location and said destination location;
wherein said plurality of alternative routes displayed on said map;
a navigation module configured to perform analysis of said plurality of alternative routes for determining a group of travel parameters selected from a group consisting of a distance, a travel time, a geographic elevation gain and loss, and an energy consumption for each of said plurality of alternative routes;
wherein determining said energy consumption is selected from a group consisting of a quantity of gasoline, a battery kilowatt-hour [kWh], and a kilocalorie;
a route table is generated for displaying said travel parameters of each of said plurality of alternative routes; and
further wherein at least one of said travel parameters is selected for optimization and one of said plurality of alternative routes is suggested with said optimization of said at least one of said travel parameters.

17. The system for optimizing travel parameters of claim 16, further wherein at least another one of said travel parameters is selected for optimization and one of said plurality of alternative routes is suggested with said optimization of said at least another one of said travel parameters.

18. The system for optimizing travel parameters of claim 16, wherein said group of travel parameters further comprise an estimated time of arrival (ETA) to said destination location for each of said plurality of alternative routes.

19. The system for optimizing travel parameters of claim 16, wherein said plurality of alternative routes are driving routes.

20. The system for optimizing travel parameters of claim 16, wherein said plurality of alternative routes are bicycling routes.
